(19) United States
(12) Patent Application Publication
(10) Pub. No.: US 2015/0336337 A1
(43) Pub. Date: Nov. 26, 2015

(54) PROCESS FOR MOLDING A 3-DIMENSIONAL PART

(71) Applicant: FIVES MACHINING SYSTEMS, INC., Fond du Lac, WI (US)

(72) Inventors: Daniel ALLMAN, Hebron, KY (US); Richard A. CURLESS, Cincinnati, OH (US); Jay S. HISSETT, Fort Mitchell, KY (US)

(73) Assignee: FIVES MACHINING SYSTEMS, INC., Fond du Lac, WI (US)

(21) Appl. No.: 14/652,946

(22) PCT Filed: Dec. 18, 2013
(86) PCT No.: PCT/US13/76029

§ 371 Date: Jun. 17, 2015

Related U.S. Application Data
(60) Provisional application No. 61/739,301, filed on Dec. 19, 2012.

(51) Int. Cl. B29C 70/56; G05B 19/4097; B29C 70/46

(52) U.S. Cl. CPC B29C 70/56; B29C 70/46; G05B 19/4097; G05B 2219/45204

(57) ABSTRACT

A process uses predictive modeling software for selectively applying relief cuts and tension to the fibers in a 2-dimensional panel prior to shaping the panel into a 3-dimensional part. The predictive modeling software identifies areas of fiber tension in the final molded product, and relief cuts are made in those areas. The plies are loaded into grippers attached to a supporting frame and predictive modeling software is used to identify areas of fiber compression in the final molded product. Tension is applied to the identified areas of fiber compression. The panel is molded in a form and cure press, and the tension is maintained on the material while closing the mold halves. The molded part is able to conform to the final mold shape without tearing in areas of tension and without material buildup in areas of compression in the final molded part or post mold distortion.

This application claims the benefit of U.S. Provisional Application Ser. No. 61/739,301 filed on Dec. 19, 2012, the entire disclosure of which is incorporated herein.

### FIELD

The invention relates to process for using predictive modeling software control for selectively applying tension and relief cuts to the fibers in a 2-dimensional composite panel prior to shaping the panel into a 3-dimensional part.

### BACKGROUND

A 2-dimensional composite panel formed from resin and reinforcing fibers may be shaped into a 3-dimensional part using a molding process. The 2-dimensional panel may be preheated to increase its formability in the mold, but as the panel conforms to the contours of the mold, the fibers in some areas are put into compression, and the fibers in other areas are put into tension.

The fiber compression results in an undesirable material buildup of excess fiber in the compression zones, bunching and wrinkling in areas of the part such as vertical wall intersections, and post-mold distortion of the molded part. The fiber tension results in potential fiber damage due to fiber stress such as fiber tearing or fiber spreading, and a loss in the ability of the panel to conform to the final mold shape without experiencing post mold distortion.

It would be desirable to reduce the fiber compression and tension that normally occurs when molding a 3-dimensional part from a 2-dimensional composite panel.

### SUMMARY OF THE PROCESS

A predictive modeling software tool is used to identify where and how much fiber compression and/or tension will occur when molding a 2-dimensional panel into a 3-dimensional part. Relief cuts are made in those areas the panel that will be put into tension in the molding process, and tension is applied to those areas of the panel that will be subjected to compression.

### BRIEF DESCRIPTION OF THE DRAWING FIGURES

FIG. 1 shows an apparatus used in the process for forming a composite panel.

FIG. 2 shows the surface of a ply of composite material with cuts formed in the surface of the ply.

FIG. 3 shows a plurality of plies of composite material stacked to form a panel.

FIG. 4 is a diagrammatic showing of a 2-dimensional panel in a tension cassette.

FIG. 5 shows apparatus used in the process for molding the 2-dimensional panel into a 3-dimensional part.

FIG. 6 shows an alternate embodiment in which the tensioning mechanisms are integrated into the molding die.

FIG. 7 shows the process of molding a 3-dimensional part from a 2-dimensional composite panel.

FIG. 8 shows an alternate process of molding a 3-dimensional part from a 2-dimensional composite panel.

### DESCRIPTION OF THE PREFERRED EMBODIMENT

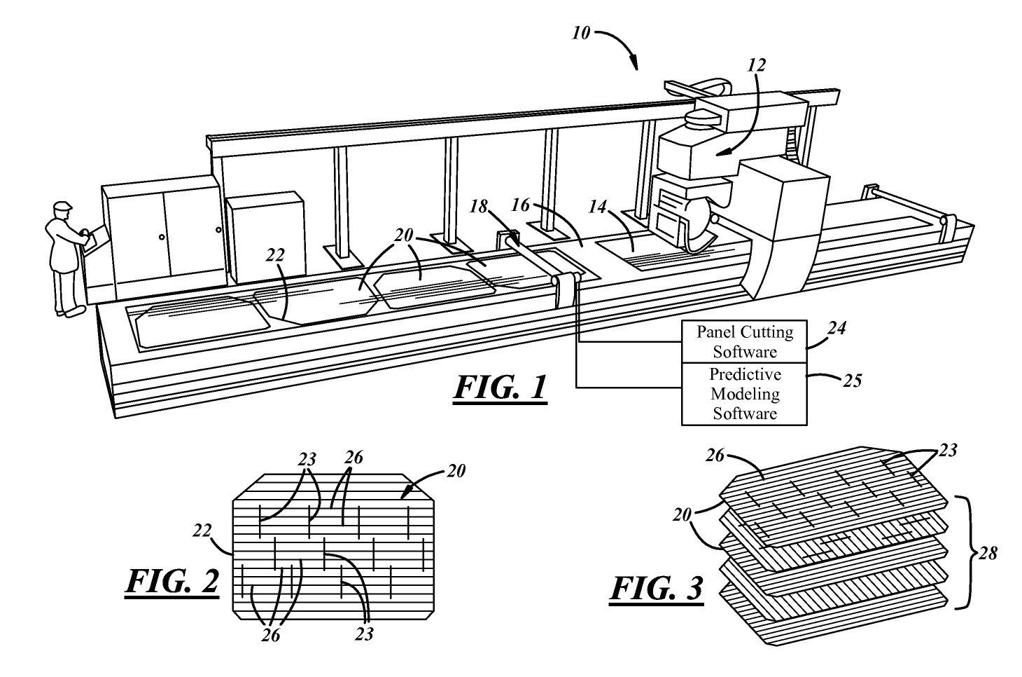

Turning now to the drawing figures, FIG. 1 shows an apparatus used in the process for forming a ply of composite material generally designated by the reference numeral 10. A fiber or tape laying machine 12 may be used to apply composite fiber or tape 14 to a receiving bed or platform 16. The composite tape 14 may comprise a unidirectional fiber in a resin matrix, although other combinations of resin and reinforcing fiber may be used. The composite tape 14 may then advanced to a cutting station 18 that may be controlled by panel cutting software 24 where it may be cut into a 2-dimensional ply 20 having a shape formed by a peripheral outline 22 that will be required for it to be formed into the final end product. The cutting station is also controlled by predictive modeling software 25 that may be used to identify where and how much fiber compression and/or tension will occur when molding the 2-dimensional ply or panel into a 3-dimensional shape. The predictive modeling software 25 may be Abaqus/Explicit finite element analysis software available from Dassault Systemes which has been modified to perform the specific function of determining areas of fiber compression and/or tension in a final molded product. The cutting station 18 may be used to form cuts 23 (best seen in FIG. 2) on those portions of the surface of the ply 20 within the peripheral outline 22 of the ply that will be subjected to tension during the molding process as identified by the predictive modeling software 25. The location of the relief cuts 23 on each of the plies 20 is determined by the predictive modeling software 25. As described in greater detail below, tension may be applied to those areas of the ply and or panel identified by the predictive modeling software 25 that will be subjected to compression in the molding process. The relief cuts 23 and the applied tension will permit the ply to better conform to a 3-dimensional mold that may be used later in the molding process.

FIG. 2 shows typical cuts 23 that may be formed in a ply 20. The cuts 23 will sever selected fibers 26 in the ply 20 that will allow the ply to conform to the shape of the final mold without tearing or spreading the fibers 26.

FIG. 3 shows that individual plies 20 may be stacked to form a multi-ply 2-dimensional composite panel 28. The forming of the composite panels 28 may be achieved by stacking the individual plies on top of one another, and the tack properties of certain resins will enable the individual plies 20 to adhere to one another. The formation of the panels 28 may also be achieved by applying a light pressure in the range of 1-300 PSI to a stack of plies. The exact pressure to be applied is determined by the nature of the specific polymer being used, the formulation and fiber volume fraction selected for the specific application, and the end use requirements.

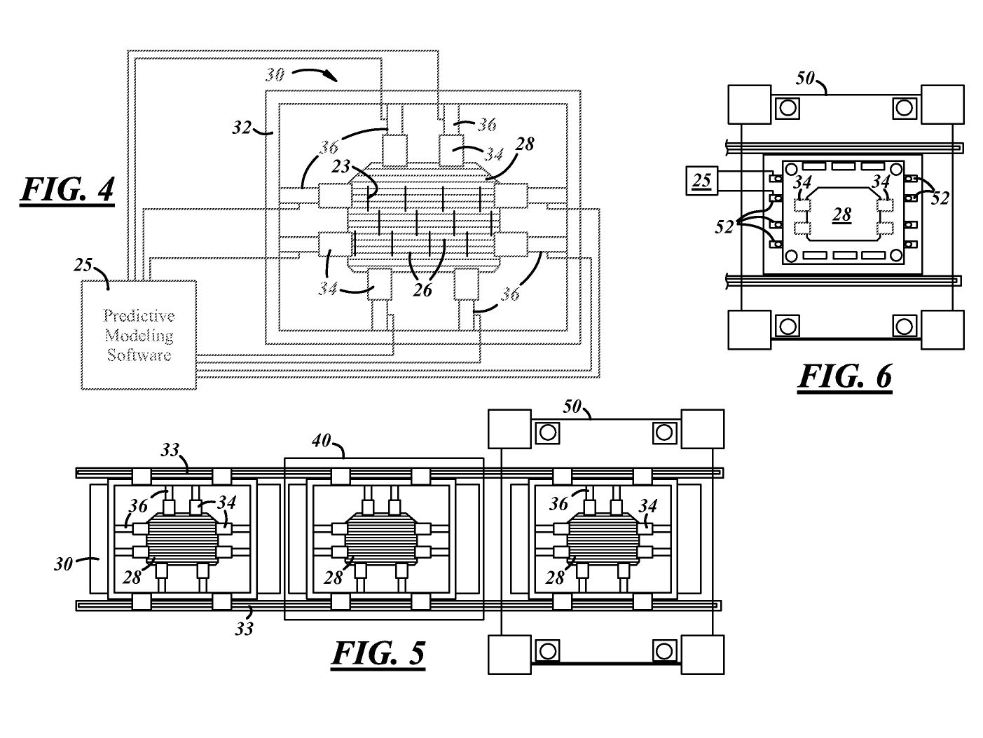

As shown in FIG. 4, prior to molding, the panel 28 may first be mounted in a frame 30 that will support it during the molding process. In one embodiment, the frame 30 may comprise a tension cassette 32. The tension cassette 32 may have grippers 34 that may grip the outer periphery of the panel 28 so that it will not droop when it is placed into the downstream preheat oven 40 and into a forming press 50 as best seen in FIG. 5. Each gripper 34 may be coupled to a tension mechanism 36 that may be used to exert a tension force on the panel 28. The tension mechanisms 36 around the tension cassette 32 may comprise linear actuators that may be individually selectively controlled to exert a tension force on selected portions of the panel 28. The amount of tension to be applied to various areas of the panel 28 may be determined and controlled by the predictive modeling software 25. Alternatively, the each gripper 34 may be coupled to a tension mechanism 36 comprising a manual actuator such a turnbuckle that may be used to exert a tension force on selected portions of the panel 28. The manual actuators may be adjusted to the required tension by human operators following a printed program or a chart of specific tensions to be applied by each gripper 34.

FIG. 5 shows the apparatus 29 used in the process for molding a 2-dimensional panel 28 into a 3-dimensional part. Once the proper tension has been set by each gripper 34, the tension cassette 32 with the composite panel 28 mounted thereon may be placed on a continuously running or an indexing conveyor 33 and advanced into a preheat oven 40. The preheat oven 40 may be used to raise the temperature of the composite panel 28 so that it will require less time in the downstream forming press and mold 50, and so that the panel will more readily conform to the contours of the mold.

After a preselected time in the preheat oven 40, the tension cassette 32 with the composite panel 28 may be advanced into the forming press and mold 50. The tension grippers 34 may be used to maintain the tension force on the composite panel 28 as the mold halves in the forming press 50 close. The tension applied to the composite panel 28 as it is being molded minimizes or eliminates fiber bunching and wrinkling in areas of the formed part such as vertical wall intersections. The cuts 23 placed in the composite panel 28 sever selected ones of the fibers 26 in the panel and allow the panel to conform to the final mold shape without fiber tearing or spreading in areas of high fiber tension. Once the composite panel 28 has been in the forming and curing press 50 for the requisite amount of time, the press may open and the molded 3-dimensional part may be removed.

In an alternate embodiment shown in FIG. 6, the frame 30 in which the composite panel 28 is placed before molding has grippers 34, but the grippers 34 are not coupled to tensioning mechanisms 36. In order to apply a tension to the panel 28 during molding, tensioners 52 may be integrated into the molding die in the forming press and mold 50. The tensioners 52 may grip the panel around the periphery of the panel 28 at the locations identified by the predictive modeling software 25 to apply the proper amount of tension force so that the material will be constrained while the forming die halves in the forming press and mold 50 are closed together during the final press molding phase.

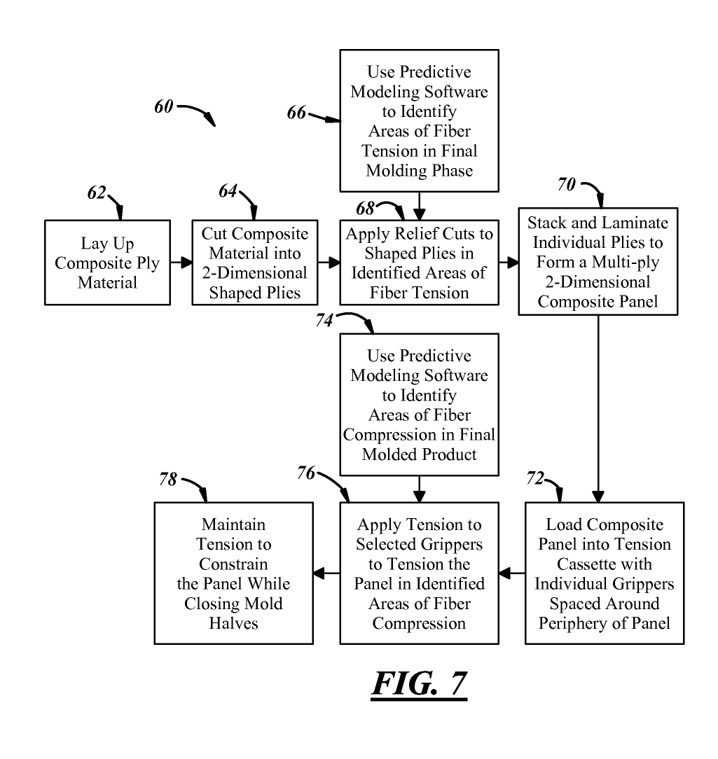

FIG. 7 shows the process 60 of molding a 3-dimensional part from a 2-dimensional composite panel using the apparatus described above. In step 62, composite material may be laid up using a fiber or tape laying head in a conventional manner. In step 64, the composite material may be cut into 2-dimensional shaped plies. In step 66, predictive modeling software may be used to identify areas of fiber tension in the final molding phase of the end product. In step 68, relief cuts may be applied to the shaped plies in identified areas of fiber tension according to the pattern determined by the predictive modeling software. In step 70, individual plies may be stacked and laminated to form multi ply 2-dimensional composite panels. In step 72, the composite panel may be loaded into a tension cassette with individual grippers spaced around the periphery of the panel. In step 74, predictive modeling software may be used to identify areas of fiber compression in the final molded product. In step 76, tension may be applied to selected grippers to tension the panel in identified areas of fiber compression. In step 78, tension may be maintained on the panel 28 to constrain the panel while closing the mold halves.

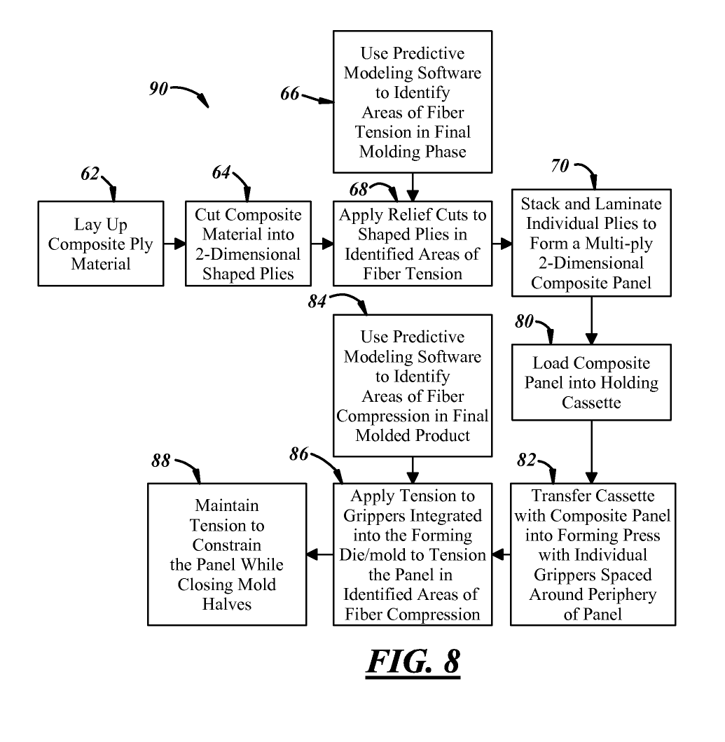

FIG. 8 shows an alternate process 90 of molding a 3-dimensional part from a 2-dimensional composite panel. The process of FIG. 8 uses the same initial steps 62 to 70 as the process of FIG. 7 described above. In step 62, composite material may be laid up using a fiber or tape laying head in a conventional manner. In step 64, the composite material may be cut into 2-dimensional shaped plies. In step 66, predictive modeling software may be used to identify areas of fiber tension in the final molding phase of the end product. In step 68, relief cuts may be applied to the shaped plies in identified areas of fiber tension according to the pattern determined by the predictive modeling software. In step 70, individual plies may be stacked and laminated to form multi ply 2-dimensional composite panels. After step 70, the panel may be loaded into a holding cassette in step 80. In step 82, the holding cassette with the composite panel may be transferred into a forming press with individual grippers spaced around the periphery of the panel. In step 84, predictive modeling software may be used to identify areas of fiber compression in the final molded product. In step 86, tension may be applied to the grippers integrated into the forming die/mold in order to tension the panel in identified areas of fiber compression. In step 88, tension applied by the grippers in the forming die/mold may be maintained to constrain the panel while closing the mold halves.

The result of the use of either of the two processes described above will be the elimination of potential fiber damage and ability to conform a 2-dimensional panel to a final 3-dimensional mold shape without experiencing post mold distortion in areas of fiber tension that are created during the molding process, and the elimination of post mold distortion and avoidance of undesirable material buildup in areas of fiber compression.

Having thus described the process, various modifications and alterations will be apparent to those skilled in the art, which modifications and alterations are intended to be within the scope of the appended claims.

1. A process for using predictive modeling software to selectively applying relief cuts and tension to the fibers in a 2-dimensional ply of fiber composite material prior to molding the ply into a 3-dimensional part, the process comprising:
laying up a 2-dimensional ply of fiber composite material;
cutting the composite material into 2-dimensional shaped plies;
loading at least one of the shaped plies into grippers attached to a supporting frame;
using predictive modeling software to identify areas of fiber compression in the final molded 3-dimensional part;
applying tension to identified areas of fiber compression of the ply;
inserting the ply into a form and cure press having mold halves; and,
maintaining the tension on the ply while closing the mold halves;
whereby the molded part is able to conform to the final mold shape without experiencing post mold distortion and undesirable material buildup is avoided in areas of fiber compression in the final molded part.

2. The process of claim 1 further comprising the steps of:
applying tension to the grippers integrated into the supporting frame in order to tension the identified areas of fiber compression of the ply.

3. The process of claim 2 further comprising:
coupling the grippers to linear actuators; and,
using the linear actuators to apply tension to the identified areas of fiber compression of the ply in the final molded part.

4. The process of claim 2 further comprising:
coupling the grippers to turnbuckles; and,
using the turnbuckles to apply tension to the identified areas of fiber compression of the ply.

5. The process of claim 1 further comprising the steps of:
integrating tensioners into the form and cure press; and,
applying tension to the grippers using the tensioners integrated into the form and cure press in order to tension the ply in identified areas of fiber compression in the molding process.

6. The process of claim 1 further comprising the steps of:
stacking at least two shaped plies together to form a multi-ply composite panel;
loading the multi-ply composite panel into grippers attached to a supporting frame; and, molding the multi-ply composite panel in the form and cure press.

7. The process of claim 1 further comprising the steps of:
using predictive modeling software to identify areas of fiber tension in the final molded 3-dimensional part; and,
applying relief cuts to the shaped plies in the identified areas of fiber tension according to the predictive modeling software; whereby post mold distortion is avoided in areas of fiber tension created during the molding process.

8. The process of claim 7 further comprising the steps of:
applying tension to the grippers integrated into the supporting frame in order to tension the identified areas of fiber compression of the ply.

9. The process of claim 7 further comprising the steps of:
integrating tensioners into the form and cure press; and,
applying tension to the grippers using the tensioners integrated into the form and cure press in order to tension the ply in identified areas of fiber compression in the molding process.

10. The process of claim 7 further comprising the steps of:
stacking at least two shaped plies together to form a multi-ply composite panel;
loading the multi-ply composite panel into grippers attached to a supporting frame; and,
molding the multi-ply composite panel in the form and cure press.

11. The process of claim 7 further comprising:
coupling the grippers to linear actuators; and,
using the linear actuators to apply tension to the identified areas of fiber compression of the ply in the final molded part.

12. The process for molding a 2-dimensional composite panel into a 3-dimensional part, the process comprising the steps of:
cutting the composite panel to a predetermined shape at a cutting station;
using predictive modeling software to identify areas of fiber tension and areas of fiber compression in the 3-dimensional part;
controlling the cutting station with the predictive modeling software to place cuts in the composite panel in the identified areas of fiber tension;
mounting the composite panel in a frame using grippers that grip the panel around its periphery;
applying tension to the grippers to apply tension to the composite panel at the identified areas of fiber compression in the 3-dimensional part;
controlling the applied tension with the predictive modeling software; and,
maintaining the tension on the composite panel during the molding of the 2-dimensional panel into a 3-dimensional part;
whereby the molded part is able to conform to a final mold shape without experiencing post mold distortion in areas of tension created during the molding process, and whereby post mold distortion and undesirable material buildup are avoided in areas of compression in the final molded part.

13. The process of claim 12 further comprising the steps of:
selectively controlling linear actuators around the frame to exert a tension force on selected portions of the panel;
advancing the part into a form and cure press once the proper tension has been set by each gripper;
maintaining the tension force on the composite panel using the linear actuators while closing the mold halves in the forming press;
whereby tension is applied to the composite panel as it is being molded to minimize or eliminate fiber bunching and wrinkling in areas of fiber compression in the molded part; and
whereby cuts are placed in the composite panel to sever selected ones of the fibers in the composite panel and allow the panel to conform to the final mold shape without fiber tearing or spreading in areas of high fiber tension in the molded part.

14. The process of claim 13 further comprising the steps of:
stacking at least two shaped plies together to form a multi-ply composite panel;
loading the multi-ply composite panel into grippers attached to a supporting frame; and,
molding the multi-ply composite panel in the form and cure press.
